(19) United States
(12) Patent Application Publication
(10) Pub. No.: US 2018/0189824 A1
(43) Pub. Date: Jul. 5, 2018

(54) SYSTEM FOR MANAGING ADVERTISING CONTENT

(71) Applicant: Apomaya, Inc., San Jose, CA (US)

(72) Inventors: Suresh Yanamadala, Redwood City, CA (US); Lev Walkin, Santa Clara, CA (US); Alexei Tumarkin, Los Altos, CA (US)

(73) Assignee: Apomaya, Inc., San Jose, CA (US)

(21) Appl. No.: 15/841,498

(22) Filed: Dec. 14, 2017

Related U.S. Application Data
(60) Provisional application No. 62/440,244, filed on Dec. 29, 2016.

(51) Int. Cl. G06Q 30/02; H04L 29/08

(52) U.S. Cl. CPC G06Q 30/0244; H04L 67/28; H04L 67/10; G06Q 30/0277; G06Q 30/0257; G06Q 30/0248

(57) ABSTRACT

A system for managing internet advertising content comprises a proxy server intermediary to an end user, a publisher of internet content, and an advertising network, wherein the publisher and the advertising network can communicate indirectly with the end user through the proxy server. The proxy server receives internet content from the publisher; detects advertising-related content in the internet content; modifies the advertising-related content; inserts an execution code into the internet content; serves the internet content to the end user; receives from the end user a request for advertising-related content; requests and receives advertising-related content from an advertising network; modifies the advertising-related content from the advertising network; and serves the advertising-related content to the end user. The end user may access the advertising-related content when the execution code is invoked by the end user.

### PRIORITY

The present application claims the benefit of domestic priority based on United States Provisional Patent Application 62/440,244 filed on Dec. 29, 2016, the entirety of which is incorporated herein by reference.

### BACKGROUND

With the penetration of the internet and increasing popularity of digital platforms, digital advertising has grown to become one of the most important forms of advertising. Digital advertising revenue worldwide is forecast to increase at a fast pace in the coming years. More than 143 billion U.S. dollars were spent on digital advertising in 2014. By 2020, this figure is projected to increase to nearly 268 billion U.S. dollars.

The increase in display advertising has been a boon for targeting advertisements to specific individual tastes, but it has also caused a hugely disruptive and annoying advertising experience. As an illustrative example, a survey conducted by HubSpot showed that more than 90% of respondents believe that advertisements are more intrusive today compared to two or three years ago and that there are more advertisements in general. Additionally, there is also concern by users that they are being tracked as a result of retargeted ads. Interestingly, 83% of respondents believe that not all advertisements are bad, but they are desirous of filtering out the advertisements they find particularly obnoxious. 77% report that they would prefer ad filtering over a complete ad blocking. More than 90% of respondents answered that they had clicked on advertisements because they were either tricked into clicking or that it was a mistake, which adds to the frustration.

It is also estimated that invalid traffic cost the US digital display advertising industry $4.6 billion in 2015, which included both the direct effect of fraudulent parties and the estimated $169 million spent to fight and address invalid traffic. It is projected that an additional $1.1 billion was lost to “malvertising,” which includes practices such as hijacking user browsers or illegally downloading viruses and software onto users' machines for the purpose of generating botnets and other deceptive tactics, including link hijacking in which fraudsters replace a legitimate link with their own ad injection where illegitimate advertisements are inserted onto legitimate publishers' sites without their knowledge.

The problem of annoying, irrelevant, intrusive, and disruptive advertisements has resulted in an exponential growth of use of Ad Blockers. According to PageFair, at least 309 million people are blocking advertisements on smartphones. A global study by Juniper research predicts that by 2020, blocked advertisements will cost digital publishers $27 billion in lost revenue. The primary reasons users give for using ad blockers are: a) advertisements are annoying and intrusive; b) advertisements are disruptive; c) advertisements create security concerns; and d) advertisements affect load time and bandwidth usage. For users, ad blocking has a become a way to regain control. While the relationship between advertisers and ad blocking companies is contentious, the two groups agree that advertisements create a problem with experience, which leads to ad blocker adoption continuing to increase over time. For the most part, websites today only have a few options to address the effects of ad blocking on their business: a) measure the ad blocking impact and provide mechanisms to re-insert advertisements, for example, PageFair; b) pay to be a part of a whitelist of the respective Ad Blockers to display ‘acceptable ads’ (this particular option is particularly disliked by the advertising industry); c) implement JAB recommended LEAN and DEAL programs or a similar variation. The success rate of these policies have been hard to track and measure, but they are the most visible to online browsers. There is also a growing concern that users are neither turning off blockers nor are they willing to pay for content. Advertising revenue is going to be the primary source for funding a free Internet and user experience is paramount.

In the current landscape of advertising ecosystem, there are a multitude of players, such as as networks, advertising exchanges providing real time bidding services, supply side providers representing publishers, demand side providers representing advertisers and many others, who work together to fill specific advertising slots on a web page. The primary mechanism to participate in this advertising delivery system is via injection of JavaScripts to the publisher's content to be executed on the end user's browsers. Adding such new code to a site naturally risks increasing page latency directly affecting end user's satisfaction and experience. “Integrating multiple partners creates more work, more resource and more latency, so it is worse for the user experience. As ever, publishers will be trying to balance good user experience versus increasing revenue,” said Julian Childs, managing director of Business Insider U.K. Once you go too far with too many demand sources, bid times will likely slow, as will the advertising loading, and there'll be diminishing returns, he added.

Thus, the detrimental impact of advertising delivery to user experience creates an urgent need for a universal solution that provides a significantly reduced latency for advertising serving, protects end users against malvertising and/or provides guarantees of content integrity according to publishers' and end users' preferences.

### SUMMARY

The present invention satisfies these needs. In one aspect of the invention, a proxy server acts as an intermediary between an end user, a publisher, and an advertising network to improve processing time, efficiency, and/or protection of internet content delivered to the end user.

In another aspect of the invention, a method for managing internet advertising content comprises receiving as an intermediary a request from an end user for internet content from a publisher, making a request to the publisher and receiving internet content from the publisher, the internet content including advertising-related content, modifying the advertising-related content, inserting into the internet content an execution code, serving the internet content including the modified advertising-related content and the execution code to the end user, receiving from the end user a request for advertising-related content, requesting advertising-related content from an advertising network and receiving the advertising-related content, modifying the advertising-related content received from the advertising network, and serving the modified advertising-related content to the end user in a manner where it may be accessed by the end user when the execution code is invoked by the end user.

In another aspect of the invention, a system for managing internet advertising content comprises a proxy server intermediary to an end user, a publisher of internet content, and an advertising network, wherein the publisher and the advertising network can communicate indirectly with the end user through the proxy server. The proxy server receives internet content from the publisher, detects advertising-related content in the internet content, modifies the advertising-related content, inserts an execution code into the internet content, serves the internet content to the end user, receives from the end user a request for advertising-related content, requests and receives advertising-related content from an advertising network, modifies the advertising-related content from the advertising network; and serves the advertising-related content to the end user. The end user may access the advertising-related content when the execution code is invoked by the end user.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic diagram of a system for managing advertising content according to one version of the invention;

FIG. 2 is a flow chart illustrating operation of the initial set up of the system of FIG. 1;

FIG. 3 is a flow chart illustrating the interaction of the system of FIG. 1 with advertising networks; and

FIG. 4 is a schematic diagram of another version of a system for managing advertising content according to the invention.

### DESCRIPTION

The present invention relates to a system for improving the manner in which advertisements (or ads) are presented to an internet user. Although the invention is illustrated and described in the context of being useful for advertisements displayed via an internet browser, the present invention can be used in other ways, as would be readily apparent to those of ordinary skill in the art. Accordingly, the present invention should not be limited just to the examples and embodiments described herein.

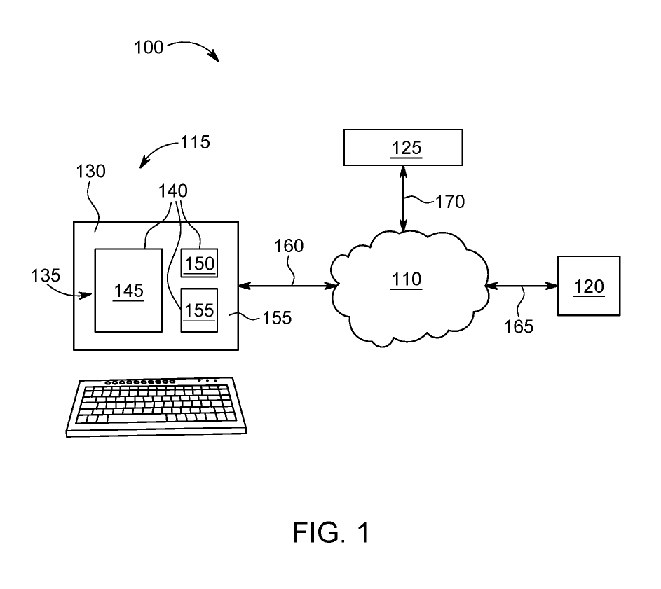

A system 100 for managing advertising content according to one version of the invention is shown in FIG. 1. The system 100 includes a proxy server 110 made up of one or more servers that acts as an intermediary between an end user 115, a publisher 120 of internet content, and an advertising network 125 (or ad network) intent on delivering advertisements to the end user 115. The publisher 120 may be any producer of internet content, such as a web page that is to be displayed to the end user 115. The publisher 120 resides on one or more servers different than the proxy server 110. The advertising network 125 may be a set of one or more servers that are collectively used to select advertisements and produce an advertising resource, such as an image or an interactive block or script, for presentation to the end user 115. The proxy server 110 may be any device, network, or system that can communicate with and act as an intermediary between the end user 115, the publisher 120, and/or the advertising network 125 in accordance with one or more features of the present invention. For example, the proxy server 110 may be in the form of a cloud proxy or cloud network made up of one or more servers.

The end user 115 may be an individual or any program that allows the individual to interact with information on the internet, such as a traditional web browser available on most computers and hand-held devices. For example, the end user 115 may be an internet browser that displays information to an individual on a display screen 130, such as a screen on a computer, television, or hand-held device. The displayed image 135 may contain one or more blocks 140 of content. In the example shown in FIG. 1, the blocks 140 of content include a publisher block 145 that visually displays internet content created by the publisher 120 and one or more advertising blocks 150, 155 that display advertising-related content, such as an advertisement, created by or delivered by the advertising network 125. Alternatively or additionally, the display may communicate with the individual through an audio and/or tactile means, and the blocks 140 of content may include audio and/or tactile data or the like.

The system 100 of the present invention provides a manner and method for improving and/or optimizing delivery of advertising-related content, as will be explained in detail. The delivery mechanism ensures that only the information that is explicitly allowed by the publisher and/or the end user is shared with an advertising network and the advertising entities associated with the advertising network. The system 100 acts as an intermediary between the end user and the advertising network and applies multiple network and content optimization techniques to achieve reduced latency and improved efficiency while controlling delivered and shared information. In particular, an end user's privacy can be protected in a manner governed by the publisher's and/or end user's preferences. The system 100 is easy-to-use and efficient and provides flexible opt-in and opt-out options for protecting an end user's privacy in a consistent manner. The system 100 and its operation may be enforceable by an end user 115 and/or by a publisher 120 who has the ownership of the content that the end user is desirous of consuming. The system 100 also ensures that only pre-approved advertisements can be displayed and that no third-party, such as an advertiser, code can be injected into the internet content served to the end user without the publisher's consent and in accordance with the end user declared preferences, and no security vulnerabilities can be incurred in the process of serving and displaying advertisements.

The present system 100 operates differently than convention internet interactions to help improve the end user experience. In a conventional system, the publisher 120 communicates directly with the end user 115. The end user 115 resolves the domain name of a publisher 120 and connects directly to the publisher's web server. The publisher 120 prepares internet content and pushes the internet content to the end user 115 where the internet content is rendered for delivery to an individual via a browser window or the like, such as by being displayed in publisher block 145. The rendered content also contains references to an advertising network 125 which allows the advertising network as a third-party to deliver scripts or advertisements to the end user, for example in advertising blocks 150, 155 where they are executed along with the internet content from the publisher 120. In contrast, with the present system 100, the publisher 120 and the advertising network 125 do not communicate directly with the end user 115. Instead, the publisher 120 and advertising network 125 communicate indirectly with the end user 115 through the intermediary proxy server 110. By providing the proxy server 110 as an intermediary, the system 100 of the present invention offers many advantages over the conventional process, particularly to the end user experience, as will be described. The proxy server establishes a connection 160 with the end user 115 and has an established connection 165 with the publisher 120 and an established connection 170 with the advertising networks 125.

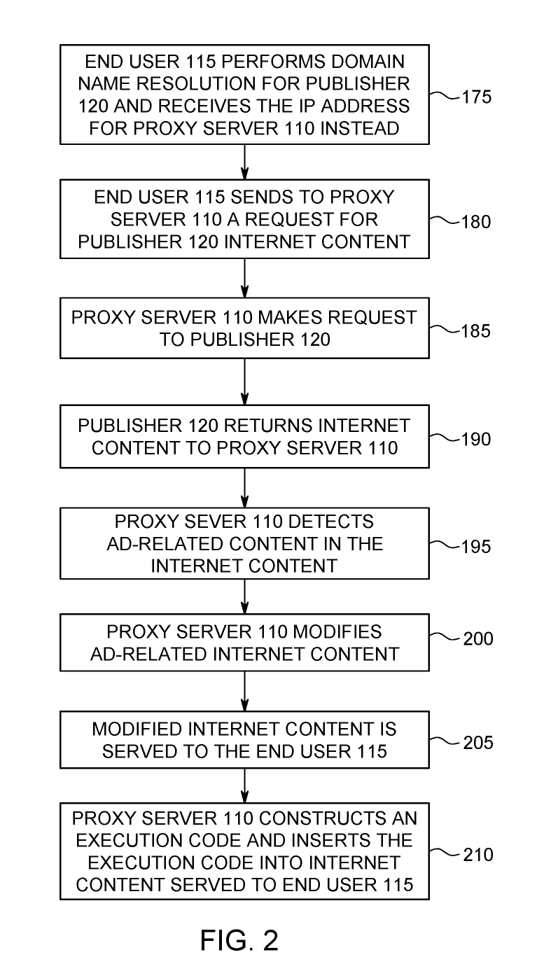

The connection 160 between the proxy server 110 and the end user 115 and between the proxy server 110 and the publisher 120 is described in FIG. 2. First, the end user 115 performs a domain name resolution 175 for the publisher 120. Typically, the end user 115 will use a search engine link or type in the domain name for the publisher 120 rather than using an IP address. The domain name is converted to the IP address via a procedure called domain name resolution (DNS) in conventional fashion. However, with the present system 100, the end user 115 actually gets the IP address for the proxy server 110 instead of the IP address for the publisher 120. The end user 115 thus connects with the proxy server 110, and the end user 115 sends 180 to the proxy server 110 a request for internet content, such as a webpage, from the publisher 120. The proxy server 110 makes a request 185 from the publisher 120. The publisher 120 returns 190 the internet content to the proxy server 110, and the proxy server 110 detects 195 advertising-related content, such as one or more ad blocks or scripts, in the internet content from the publisher 120. The proxy server 110 modifies 200, such as by rewriting, the internet content and/or the advertising-related content. For example, in one version, the proxy server 110 modifies the ad-related content by scrambling it. The modified internet content including the modified advertising-related content is then served 205 to the end user 115.

In addition to rewriting the content of the web page to remove explicit references to advertising-related content and links, the proxy server 110 constructs 210 an execution code that is executable by the end user 115. When executed by the end user 115, the execution code restores the original references to the advertising-related content. In one version, the advertising-related content is scrambled or obfuscated, and the execution code descrambles of un-obfuscates the content when executed or invoked by the end user 115. The modified advertising-related content is thus able to be delivered to the end user 115 in a manner where it is more efficiently and speedily delivered and/or in a manner where is can go undetected by ad blockers, as will be described.

When the execution code is executed by the end user 115, the end user 115 and the proxy server 110 utilize an already existing connection or create a connection, such as a persistent connection. In one version of the invention, an additional persistent connection is accomplished by using a websocket. A websocket is a computer communications protocol providing multiple communication channels over a single transmission control protocol. In one particular version, a preferred websocket protocol is RFC 6455. The execution code running within the end user 115 also continuously pushes information to the proxy server 110 about the end user's browser information, such as window dimensions, position of the scroll bar, cursor, and other run time details in addition to updates on the individual's behavior.

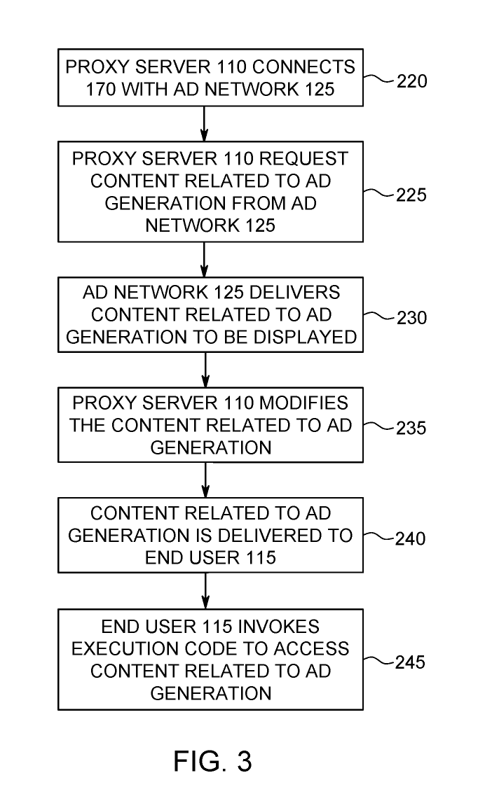

Once the connection is established between the end user 115 and the proxy server 110, the proxy server 110 interacts with the advertising network 125 as shown in FIG. 3. A connection 170 between the proxy server 110 and the advertising network 125 is established 220. For each advertising-related content, such as one or more advertising blocks or scripts, that was modified and served to the end user 115, the proxy server 110 requests 225 advertising-related content, such as an advertisement, to be delivered or served to the end user 115 according to existing programmatic advertisement generation and fulfillment procedures, thus resulting in no changes to standard protocols and algorithms on the advertising platforms side. The advertising network 125 then delivers 230 the advertisement that is to be displayed to the end user 115. The proxy server 110 then translates 235 the advertisement by modifying it, such as by rewriting and/or scrambling it. The end user 115 then receives 245 the advertising-related content and invokes or executes the execution code to access, such as by descrambling, the advertising-related content. The advertising-related content, such as an advertisement, can then be displayed by the end user 115. Additionally or alternatively, the proxy server 115 may perform other functions, such as performing fraud checks on the advertising-related content, before delivering 240 the advertisement to the end user 115.

The proxy server 110 thus uses the flow of information to create a server-side browser-like environment. The browser-like environment is used to execute the modified internet content including excised and/or rewritten advertising blocks or scripts. The advertising network's blocks or scripts are thus getting executed as if they were on the end user, while in a simulated browser-like environment which mimics the end user's browser with improved fidelity. In one version of the invention, the communication with the advertising network 125 and the rewriting of the advertising content is achieved by a server-side browser shadowing environment and/or end user-side instrumentation. Many corporate websites make extensive use of Javascript and rewriting URL's in Javascript. This is similar to the use of Javascript and rewriting URL's in Javascript in a corporate environment, where these functions are currently implemented within so called clientless or browser-based SSL VPN gateways providing secure remote access to internal resources.

The system 100 is constructed in a way to improve and optimizing delivery of advertising-related content to an end user 115. The invention acts as an intermediary between end users and advertisers and applies multiple network and content optimization techniques to achieve reduced latency and improved efficiency while controlling delivered and shared information. The delivery mechanism ensures that only the information that is explicitly allowed by the publisher 120 and/or the end user 115 is shared with the advertising network 125. In particular, end user's privacy can be protected in a manner governed by the publisher's and/or end user's preferences. In addition, the adverse effect of ad blockers is eliminated by delivering all advertisements through the system. Ad fraud is detected and curtailed by reducing the ability of malicious browser plug-ins and network bots to impersonate legitimate users.

The present system 100 can reduce the lag time often associated with internet advertisements when an advertising network 125 is allowed to display advertisements to an end user 115 as a third party. For example, while downloading an advertising network's block or script, an end user's browser might receive several redirects, JavaScript insertions and instructions to render more content from third- and fourth-party web servers that are part of a large advertising network 125. Once the final redirect or advertisement image insertion is performed, the final resource, such as an advertisement image, a flash block, or the like, is displayed in the appropriate browser screen's position or otherwise presented to the user. These redirects can greatly slow the display process.

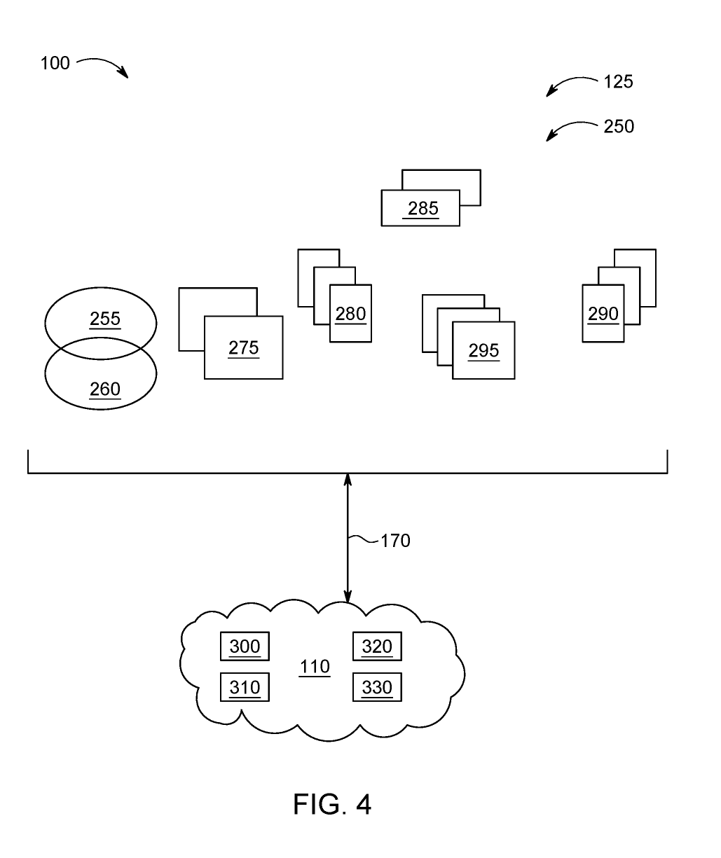

In one version of the invention, the system 100 intercepts and controls advertisements that result from a complex advertising network 125. FIG. 4 shows a multi-entity advertising network 250 and the complexities involved. In this version, the advertising network 125 comprises one or more advertisers 255 who interact with advertising creatives 260, market advertising servers 275, demand-side platforms (DSP) 280, data management platforms (DMP) 285, supply-side platforms (SSP) 290, and advertising exchanges 295. As indicated above, all of these interactions preserve the current exchanges between the end users and advertising ecosystem with the system 100 servicing these exchanges on behalf of the end user.

Thus, the proxy server 110 can act as a tunnel to the end user 115. The proxy server 110 can front-end all advertising network entities (advertisers, DSPs, DMPs, SSPs, Publishers, etc.) to the end user 115. The proxy server 110 can create a single, unique marker (cookie, supercookie, or the like) to track the end user 115 while aliasing all 3rd party trackers to this single marker. The proxy server can keep a mapping of all 3rd party trackers to this single marker and thereby transparently communicate on behalf of the end user 115 to these third-party systems.

As can also be seen in FIG. 4, in one version of the invention the system 100 includes a proxy server 110 comprising one or more modules, such as a proxy domain content rewriting engine 300, a controller 310, a JavaScript execution engine 320, and a machine-learning module 330. In one particular version, the proxy server comprises the proxy domain content rewriting engine 300, the controller 310, and optionally one or both of the JavaScript execution engine 320 and the machine-learning module 330. The JavaScript execution engine 320 performs some or all tasks of executing JavaScript rather than having them all performed by the end user, thus reducing processing and content access time to improve the end user's experience. The JavaScript execution engine 320 may also simultaneously perform advertising-related activities such as interactions with the third-party servers. The machine learning module 330 may be used to reduce the risk of errors in content rewriting and to predict interactions with third-party servers without the need to execute all scripts on the end user. Additional similar modules could also be employed.

The proxy domain content rewriting engine 300 is a request/response processor and utilizes either the same domain as the original content or a special sub-domain for delivery of all advertising-related information. The proxy domain content rewriting engine 300 is resolved to the proxy server 110 to ensure privacy and security controls. In one version of the invention, the system 100 replaces all links to an advertising network 125 to point to a proxy domain and creates a unique cookie/supercookie (UC) for tracking purposes. The proxy servers 110 aliases UC to all third-party trackers. The proxy server 110 where necessary provides a JavaScript passthrough for 3rd party domains but executes them on behalf of the 3rd party domains. The proxy server 100 can use a JavaScript execution module to minimize the repeated execution of the same/similar automatically or manually defined script fragments for a given publisher.

The controller 310 is a cloud-based policy enforcement engine that can control the exchanges of information between the end user 115, the publisher 120, and the advertising network 125. Per publisher 120 and/or per end user 115 configuration, the controller 310 maintains and enforces tracking and data exchange policies. The controller 310 manages publisher-defined allow/block preferences for 3rd party trackers. The controller 310 also manages end user-defined allow/block preferences for 3rd party trackers. For ease of the end user's preference management, the controller 310 provides for default profiles typically derived from the publisher preferences.

In addition, the proxy server 110 implements various techniques for reducing latency and improving bandwidth utilization. For example, the proxy server 110 may implement compression technologies, transmission control protocol (TCP) optimization, caching, and the like. Such techniques and their implementations are known in the art.

The system 100 can operate in various modes. For example, in full intercept mode, the end user 115 interacts with all advertising networks 125 through the proxy server 110. In a hybrid or partial intercept mode, the end user 115 interacts with one or more advertising networks 125 through the proxy server 110 and interacts with one or more selected advertising networks 125 directly. In yet another version, the proxy server 110 does not directly communicate with an advertising network 125. Sometimes, a publisher 120 will serve advertisements by itself without interacting with an advertising network 125. In this case, the proxy server 110 can still modify the advertising-related content through encryption, scrambling, and/or obfuscation of the advertising-related content and corresponding links in order to help optimize the display of the advertisements and/or bypass ad blockers.

The system 100 of the present invention offers several features and advantages over the convention advertising delivery systems. Some of these features and advantages will now be discussed.

### Control Groups

The system 100 enables publishers 120 to choose certain end users as control groups. This can be done to verify the efficacy and efficiency of the applied technologies and to provide a way to quantify the benefits of different variants of a solution. Such control groups can be defined based on geography (country, county, city, etc.), network/ISP, or by IP block lists. For control groups, the system 100 will preserve the original advertising code/interactions and only gather information for monitoring purposes. The publisher 120 can maintain full control over the duration of the system's treatment of each control group. For example, the publisher 120 may keep a control group for 3 months and then initiate an application of the present system 100 thereafter to improve the user experience for the control group's members.

### Ad Fraud Protection

The system 100 of the present invention provides a direct way to detect and help fight ad fraud. In this innovative approach due to the fact that the invention screens and intercepts all ad-related interactions, the system 100 can detect the presence of a malicious browser plug-in that inserts any foreign links. In addition, because the system 100 proxies all legitimate advertising requests, an advertising network 125 can choose to block all requests coming from servers not associated with the system, such as bots.

### Multi-Platform and Multi-Target Implementations

The system 100 according to one aspect of the invention lends itself to publisher's integration with multiple advertising platforms and targeting multiple audiences. The system 100 has access to content and user information, and it implements adaptive rewriting algorithms. Therefore, the system 100 can provide direct and efficient controls for the publisher 120 to specify the rules for inserting advertising code into its pages and selecting different code depending on the end user location and other characteristics of publisher and advertiser choosing.

### Ad Preservation and Avoiding Ad Blockers

The system 100 according to the invention can detect the presence ad blockers and rewrite corresponding URLs to avoid blocking. The delivery of third-party advertisements are converted to a 1st party by virtue of the proxy server 110 using the same domain or a sub-domain of the publishers' domain thus avoiding blocking by recognizing a well-known advertising domain and/or advertiser's IP address. Additionally, the ad-related URLs are obfuscated to avoid blocking by address part. For example, a rule that tries to find links such as /banner/*/imĝ will fail because the rewritten URL's will look like L2Jhbm51ci9hZHZ1cnRpc2VyL21tZy9iYW5uZXluanBn. This example uses a base64 encoding of the path “/banner/advertiser/img/banner.jpg”. The system 100 may use more secure methods, such as encryption, to make such obfuscation completely obscure to ad blockers.

### Selective Rewriting

The system 100 can use a client-side JavaScript code to detect the presence of ad blockers by comparing the DOM elements with the original links. If such an ad blocker is detected, then all advertising content is forced through a publisher's domain, either a special domain or the same domain that is used for delivery of the base HTML. Additionally, the paths and file names are obfuscated in order to avoid blocking by a match to a certain string in URL, such as ads.js. If no ad blockers are detected then the publisher 120 can choose to allow some or all advertising links to be kept intact to reduce transmission costs and preserve the original protocol interactions. In combination with publisher/user based preferences is a powerful mechanism to preserve ads.

Contextual Advertisement Matching

Contextual advertising or context match refers to the placement of commercial advertisements within the content of a web page. The system 100 provides means for contextual advertisement matching based on a combination of semantic and syntactic features. In one implementation, the system 100 inserts such information as keywords and page description and title into a custom HTTP header (or a set of headers) passed to the advertising networks on subsequent requests from the end user browser. More advanced techniques of context analysis, application of various classification and categorization algorithms, natural language processing coupled with URL link analysis can potentially yield more in-depth information about the page and its relevance to various advertisements. By analyzing the text or image of the resulting ad, the system 100 can provide the publisher 120 with an automated way of rejecting the advertisements that are not relevant to the displayed original content. For example, if there is a vocabulary mismatch between the page and the textual advertisement, then such advertisement can be rejected.

### Techniques Used to Optimize End User Experience

A first technique useful for improving or optimizing an end user experience is network acceleration. Network acceleration eliminates the last mile to-and-from traffic by terminating 3rd party trackers at the controller 310. Network acceleration also provides TCP-based optimizations (pacing, fast retransmits etc.) for last-mile traffic.

A second technique useful for improving or optimizing an end user experience is content acceleration. Content can be accelerated by optimizing JavaScript execution and a combination of asynchronous and delayed execution. When the system 100 determines that original content includes synchronous JavaScript calls, it converts them to asynchronous ones. Non-essential JavaScripts can be delayed and loaded into browsers while the end user is already accessing core content, thus significantly improving performance and perception of the quality of the site. Content can also be accelerated by websocket stream compression of all content including HTTP headers.

Another technique useful for improving or optimizing an end user experience is publisher content and advertisement security. The system 100 enables improved HTTPS based services to end users in all cases where such services were not implemented or caused additional latency. HTTPS connections are terminated at proxy (end user to Proxy; Proxy to Publisher; Proxy to Advertising ecosystem where feasible). The system 100 also enables advertisements and trackers with HTTPS content whenever such advertisements were not delivered via the TLS secure protocol. Such TLS termination has additional benefits, such as reducing latency by eliminating all TLS handshakes except one for the main domain and offloading challenging tasks of establishing TLS connections.

The system 100 also provides improved privacy protection. Based on end users' and publishers' preferences, the system 100 provides configurable options for choosing proper tracking preferences. The publisher 120 can control which information about end users is shared with advertisers and their agents, and end users 115 have access to setting up such preferences in the displayed ads. As an additional and optional service, the system 100 has a dedicated online site for an end user 115 to specify what information they are willing to share with advertisers employed by the publishers that are using the invention and which content they prefer to see as advertisements on the corresponding sites and applications. Such centralized way of submitting user preferences benefits both the end user 115, who needs to do it once and be protected until they change their preferences, and to the system 100 invention itself which now has a direct way of monetizing the available information with the consent of the end user 115. In addition, the system 100 can use such prepared information to satisfy an advertising network's requirements without additional interactions with the end user's device.

The system 100 also implements header bidding in an effort to maximize revenues for a publisher 120. It enables multi-platform advertising exchanges and/or SSPs to bid for specific inventory in a page and selects the highest yield advertisements per publishers' policies. It avoids/offsets the overhead a user's device has to incur in implementing header bidding.

The system 100 enables targeting and retargeting. The system 100 can learn end user preferences and provides this as additional information to advertising networks for better targeting and retargeting. This also helps avoid annoying, irrelevant advertisements to be displayed to the user.

Thus, the system 100 provides in a proxy server 110 communicating with a publisher 120, such as a publisher server, a method of transforming internet content received from the publisher 120. The method includes the steps of receiving a request from at least one end user 115 for the main content residing on the publisher server, the content including and referencing additional content residing on at least one server other than the publisher server; modifying, such as by rewriting, the main content and inserting special instructions for processing on the end user 115, such as an end user execution code; and transmitting the rewritten content including the special transformation instructions to be performed by the end user 115. The transformation on the proxy server 110 results in (i) some or all external content links being modified or rewritten so that they are served from the same domain as the main content, (ii) some external content links being rewritten so that they are served from a different domain but still under the control of the owner of the main content, (iii) some or all external content links being rewritten so that they are served from the same domain as the main content, and/or (iv) some external content links being rewritten so that they are served from a different domain but still under the control of the owner of the main content. The transformation may result in variants of (i) to (iv) with at least some parts of the links being modified so they are obfuscated or encrypted and prevent recognition of their purpose, such as by an ad blocker.

The system 100 also provides in a proxy server 110 communicating with a publisher 120, such as a publisher server, a method of transforming internet content received from the publisher server including receiving a request from at least one end user 115 for the main content residing on the publisher server, the content including additional content, such as content related to advertising generation; modifying, such as by rewriting, the main content and inserting special instructions for processing on the client, such as an end user execution code; and transmitting the modified or rewritten content including the special transformation instructions to be performed by the end user. The transformation on the proxy server 110 results in (i) all or some additional content being rewritten so that it is indistinguishable from the main content and not detectable by an ad blocker, for example by application of a keyword matching algorithm or by any other means such as a regular expression searches for a particular set of characters or a combination of characters and/or (ii) all or some additional content being rewritten so that it is indistinguishable from the main content and not detectable by an ad blocker, for example by application of a keyword matching algorithm or by any other means such as a regular expression searches for a particular set of characters or a combination of characters. The transformation can result in a variant of (i) and (ii) where the rewriting involves some known methods of modification by obfuscation or encryption. The proxy can employ various methods of speeding up interactions with the clients and third-party servers such as SSL offload, pre-loading of links and DNS prefetching, re-use and multiplexing connections and requests. The proxy server 110 can do third-party cookie handling on behalf of the end user 115. The proxied requests to the third-party servers may contain contextual and semantic information about the main content. The proxy can analyze the responses containing the third-party content and apply pre-set filtering rules according to the publisher's policies such as filtering by domain name, filtering by keywords and context, filtering using image and video frames recognition, filtering based on content and advertising efficacy and performance transformation rules, and anonymizing client's IP address and other privacy data thus implementing compliance to various privacy regulations.

The system 100 can also provide a manner for complete reporting on viewability of all elements of a webpage including advertising content as well as the click history of clickable links on the page, script insertion to peer into viewability of page elements, and coalescing and aggregating viewability elements by the proxy at a page and site level. Viewability metrics can be gathered on a per element basis, for example iframe which has an advertising creative. These can be coalesced to gather a per page viewability metric while aggregated to get statistics at a page, site, third-party, etc. levels. Predictive viewability metrics can be established and communicated to third-parties for optimizing advertisement selection.

Although the present invention has been described in considerable detail with regard to certain preferred versions thereof, other versions are possible, and alterations, permutations and equivalents of the version shown will become apparent to those skilled in the art upon a reading of the specification and study of the drawings. For example, the cooperating components may be reversed or provided in additional or fewer number. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

What is claimed is:

1. A method for managing internet advertising content, the method comprising:
receiving as an intermediary a request from an end user for internet content from a publisher;
making a request to the publisher and receiving internet content from the publisher, the internet content including advertising-related content;
modifying the advertising-related content;
inserting into the internet content an execution code;
serving the internet content including the modified advertising-related content and the execution code to the end user;
receiving from the end user a request for advertising-related content;
requesting advertising-related content from an advertising network and receiving the advertising-related content;
modifying the advertising-related content received from the advertising network; and
serving the modified advertising-related content to the end user in a manner where it may be accessed by the end user when the execution code is invoked by the end user.

2. A method according to claim 1 wherein the modifications to the internet content and the advertising-related content result in the internet content and the advertising-related content being accessed by the end user with reduced latency than if the modifications had not been made.

3. A method according to claim 1 wherein the modifications to the advertising-related content make the advertising-related content less recognizable to an ad blocker than if the modifications had not been made.

4. A method according to claim 1 wherein the modified advertising-related content is displayed by the end user when the execution code is invoked by the end user.

5. A method according to claim 1 wherein the advertising-related content received from the publisher is an advertisement block.

6. A method according to claim 1 wherein the advertising-related content received from the advertising network is an advertisement.

7. A method according to claim 1 further comprising performing a fraud check on the advertising-related content before it is served to the end user.

8. A system for managing internet advertising content, the system comprising:
a proxy server intermediary to an end user, a publisher of internet content, and an advertising network, wherein the publisher and the advertising network can communicate indirectly with the end user through the proxy server,
wherein the proxy server:
receives internet content from the publisher,
detects advertising-related content in the internet content,
modifies the advertising-related content,
inserts an execution code into the internet content,
serves the internet content to the end user,
receives from the end user a request for advertising-related content,
requests and receives advertising-related content from an advertising network,
modifies the advertising-related content from the advertising network; and
serves the advertising-related content to the end user,
whereby the end user may access the advertising-related content when the execution code is invoked by the end user.

9. A system according to claim 8 wherein the proxy server is a cloud proxy or cloud network made up of one or more servers.

10. A system according to claim 8 wherein the advertising network comprises one or more servers used to select advertisements and/or produce an advertising-related resource.

11. A system according to claim 8 wherein the advertising-related content from the publisher is an advertising block or script.

12. A system according to claim 8 wherein the advertising-related content from the advertising network is an advertisement.

13. A system according to claim 8 wherein the end user is a program that allows an individual to interact with internet content.

14. A system according to claim 13 wherein the program is an internet browser that displays internet information on a screen.

15. A system according to claim 8 wherein the publisher and the advertising network communicate with the end user only through the proxy server.

16. A system according to claim 8 wherein the proxy server ensures that only pre-approved advertising-related content can be delivered to the end user and no third-party code can be delivered.

17. A system according to claim 8 wherein the modified internet content served to the end user has reduced latency than if the internet content from the publisher and the advertising-related content were delivered to the end user without being modified.

18. A system according to claim 8 wherein the modified advertising-related content is less recognizable to an ad blocker than if the modifications had not been made.

19. A system according to claim 8 wherein the proxy server performs a fraud check on the advertising-related content before serving the advertising-related content to the end user.

20. A system according to claim 8 wherein the proxy server can operate in one or more modes, wherein the modes comprise a full intercept mode where the end user interacts with all advertising networks through the proxy server and a partial intercept mode where the end user interacts with an advertising network through the proxy server and with an advertising network directly.
